(19) United States
(12) Patent Application Publication
(10) Pub. No.: US 2013/0041990 A1
(43) Pub. Date: Feb. 14, 2013

(54) METHOD AND APPARATUS FOR IMPROVING THROUGHPUT OF A MODEM

(71) Applicants: Brian K. Thibeault, Attleboro, MA (US); Michael J. Cooper, Augusta, GA (US); John L. Moran, Uxbridge, MA (US); Steve F. Nikola, North Easton, MA (US)

(72) Inventors: Brian K. Thibeault, Attleboro, MA (US); Michael J. Cooper, Augusta, GA (US); John L. Moran, Uxbridge, MA (US); Steve F. Nikola, North Easton, MA (US)

(73) Assignee: GENERAL INSTRUMENT CORPORATION, Horsham, PA (US)

(21) Appl. No.: 13/207,966

(22) Filed: Aug. 11, 2011

(51) Int. Cl. G06F 15/173

(52) U.S. Cl. 709/223

(57) ABSTRACT

A network element is registered on a physical channel and a first logical channel. The network controller receives ranging messages from which network element parameters associated with the network element are determined, and the network determines if the network element is better suited for a different logical channel on the network. The network controller provides an upstream channel change override signal to the network element, instructing the network element to re-register to another logical channel.

### FIELD OF THE INVENTION

This disclosure is directed toward improving throughput for a network element in a network.

### BACKGROUND OF THE INVENTION

Cable television systems have been in widespread use for many years and extensive networks have been developed. The extensive and complex networks are often difficult for a cable operator to manage and monitor. A typical cable network generally contains a headend which is usually connected to several nodes which provide content to a cable modem termination system (CMTS) containing several receivers, each receiver connects to several modems of many subscribers, e.g., a single receiver may be connected to hundreds of modems which vary widely in communication characteristics. In many instances several nodes may serve a particular area of a town or city. The modems communicate to the CMTS via upstream communications on a dedicated band of frequency.

Cable networks are also increasingly carrying signals which require a high quality and reliability of service, such as voice communications or Voice over IP (VoIP) communications. Any disruption of voice or data traffic is a great inconvenience and often unacceptable to a subscriber.

The CMTS (Cable Modem Termination System) will be configured to be running multiple logical channels per physical upstream channel. Each logical channel will have a different modulation profile configured (but not limited to) such as quadrature phase shift keying (QPSK), 16QAM (quadrature amplitude modulation) and 32QAM. Logical channel operation is a mechanism whereby multiple upstream channels may be configured with different operating parameters, e.g. modulation modes, while all operating on the same physical channel. DOCSIS 2.0 introduced this concept to support simultaneous operation and therefore backwards compatibility of TDMA, ATDMA, and SCDMA cable modems.

There are many different types of cable modems that are used by subscribers. Many still in use are only capable of running error free at the QPSK modulation mode. In order to keep data passing as error free as possible CMTS products will set the modulation profile of an upstream channel to the lowest modulation mode to achieve this error condition for all modems. In doing this the modems that are capable of passing data error free at higher modulation modes (and higher throughput) are penalized and do not achieve their potential throughput.

When a cable operator configures the CMTS upstream ports with logical channels they will use a different modulation profile for each one. An example would be to have logical channel 0 running QPSK, logical channel 1 running 16QAM, logical channel 2 running 32QAM and logical channel 3 running 64QAM. This is just an example because some CMTS cards may not have as many as 4 logical channels.

Commonly assigned US Publication 20070223512 attempts to improve throughput by moving modems to the correct upstream logical channel after the modem has registered. It does this by invoking either the upstream channel change (UCC) or dynamic channel change (DCC) protocol to move the modem. While the approach may work well under ideal conditions, many modems do not handle those protocols properly. If the modems fail to move with those protocols then they may possibly deregister causing loss of service for subscribers. Accordingly, what is needed is a reliable and cost effective approach to assigning modems to a preferred logical channel to improve throughput.

### SUMMARY OF THE INVENTION

In accordance with the principles of the invention, an apparatus for configuring logical channels in a network may comprise: a microprocessor configured to determine network parameters associated with a selected network element and in cooperation with the selected network element; and a receiver configured to receive signals indicative of the network element parameters from a network element during a registration process in which the network element is registered on a first logical channel, wherein the microprocessor may be configured to assign the network element to a logical channel based on the network element parameters and to instruct the network element to re-register with the network on a second logical channel different from the first logical channel.

In the apparatus, the network element parameters may include a modulation error ratio (MER) or a signal to noise ratio (SNR). The microprocessor may compare the network parameters with threshold values and assigns the network elements to a logical channel based on the comparison. The microprocessor may provide instructions to the network element to re-assign to a third logical channel different from the second logical channel. The microprocessor may assign the network element to the second logical channel using an upstream channel override signal.

In accordance with the principles of the invention, a method for configuring logical channels in a network may comprise the steps of: determining network parameters associated with a network element based on network parameters received from the network element during a registration process in which the network element is registered on a first logical channel; analyzing the network parameters; and assigning network elements to a second logical channel based on the network parameters, and to instruct the network element to re-register with the network on the second logical channel different from the first logical channel.

In the method, the network parameters may include a modulation error ratio (MER) or a signal to noise ratio (SNR). The step of assigning network elements to logical channels includes comparing the network parameters with threshold values and assigning the network elements to a logical channel based on the comparison. The method may further include the step of providing instructions to the network element to re-assign to a third logical channel different from the second logical channel. The step of assigning the network element to a second logical channel may include instructing the network element to the second logical channel using an upstream channel override signal.

In accordance with the principles of the invention a non-transitory computer readable medium may carry instructions for a computer to perform a method for configuring logical channels in a network comprising the steps of: determining network parameters associated with a network element based on network parameters received from the network element during a registration process in which the network element is registered on a first logical channel; analyzing the network parameters; and assigning network elements to a second logical channel based on the network parameters, and to instruct the network element to re-register with the network on the second logical channel different from the first logical channel.

In accordance with the principles of the invention, a network element in a network may comprise: a microprocessor configured to register with a network on a physical channel and a first logical channel and to provide messages indicative of network element parameters associated with the network element's ability to communicate on the channel; and a receiver configured to receive a upstream channel override signal; wherein the upstream channel override signal instructs the network element to re-register on a second logical channel. The network element parameters may include a modulation error ratio (MER) or a signal to noise ratio (SNR). In the apparatus the microprocessor may re-register with the network on the second logical channel.

In accordance with the principles of the invention, a method for configuring logical channels element in a network may comprise the steps of: registering with a network on a physical channel and a first logical channel; providing messages indicative of network element parameters to a network controller; receiving an upstream channel override signal; and re-registering the network element on a second logical channel different from the first logical channel. The network element parameters may include a modulation error ratio (MER) or a signal to noise ratio (SNR).

In accordance with the principles of the invention, a non-transitory computer readable medium may carry instructions for a computer to perform a method for configuring logical channels in a network comprising the steps of: registering with a network on a physical channel and a first logical channel; providing messages indicative of network element parameters to a network controller; receiving an upstream channel override signal; and re-registering the network element on a second logical channel different from the first logical channel. The network parameters may include a modulation error ratio (MER) or a signal to noise ratio (SNR).

The system preferably allows an operator to automatically configure the CMTS to best align the network elements with the available logical channels. The invention provides a cost effective manner for improving network element throughput, providing higher data speeds to subscribers. The total network throughput may also be increased in addition to individual subscriber throughput because each network element will be running at its best possible modulation mode and it should not bring other modems down (to a lower bandwith) with it. All the modems that can only run in QPSK will be on the QPSK channel, the modems that can run at 16QAM will be on the 16QAM channel and so on. The invention may be done in real time so there are no operator configuration changes or intervention where they could make a mistake and assign a network element to the wrong channel. Another advantage is that there is no or little dollar cost to cable operators to get better throughput.

### BRIEF DESCRIPTION OF THE DRAWINGS

The following drawings serve to illustrate the principles of the invention.

FIG. 1 illustrates an exemplary network in accordance with the principles of the invention.

FIG. 2 illustrates a logical architecture of an exemplary CMTS 10 to facilitate an understanding of the invention.

FIG. 3 illustrates an exemplary network element 8, such as a cable modem.

FIG. 4 illustrates an exemplary process performed by a CMTS for automatically registering a network element on a preferred logical channel.

FIG. 5 illustrates an exemplary process in a network element for registering with a network in accordance with the principles of the invention.

### DETAILED DESCRIPTION OF THE INVENTION

The invention provides an effective ability to maximize the data throughput of each network element subscriber (and the CMTS total throughput) at the time each network element registers with the CMTS. The CMTS uses logical channels to help perform this task. Network elements are assigned (re-registered), using instructions from the CMTS, such as the upstream channel override protocol, to the logical channel that supports the modulation error ratio (MER) or signal to noise ratio (SNR) threshold that each network element meets or exceeds when it registers. If the network element is already on the correct channel it will remain there. This way the network element is transmitting at its best modulation mode and therefore can maximize its data passing. This algorithm can be performed on any CMTS product used for high speed internet access.

The network can differentiate cable modems by Modulation Error Ratio (MER) which is a primary determinant in the modulation rate (QPSK, 16QAM, 32QAM, 64QAM, etc) that may be run, and then set up multiple logical channels, each one with a different modulation rate, and then assign the appropriate network elements to each logical channel based upon which modulation could be supported.

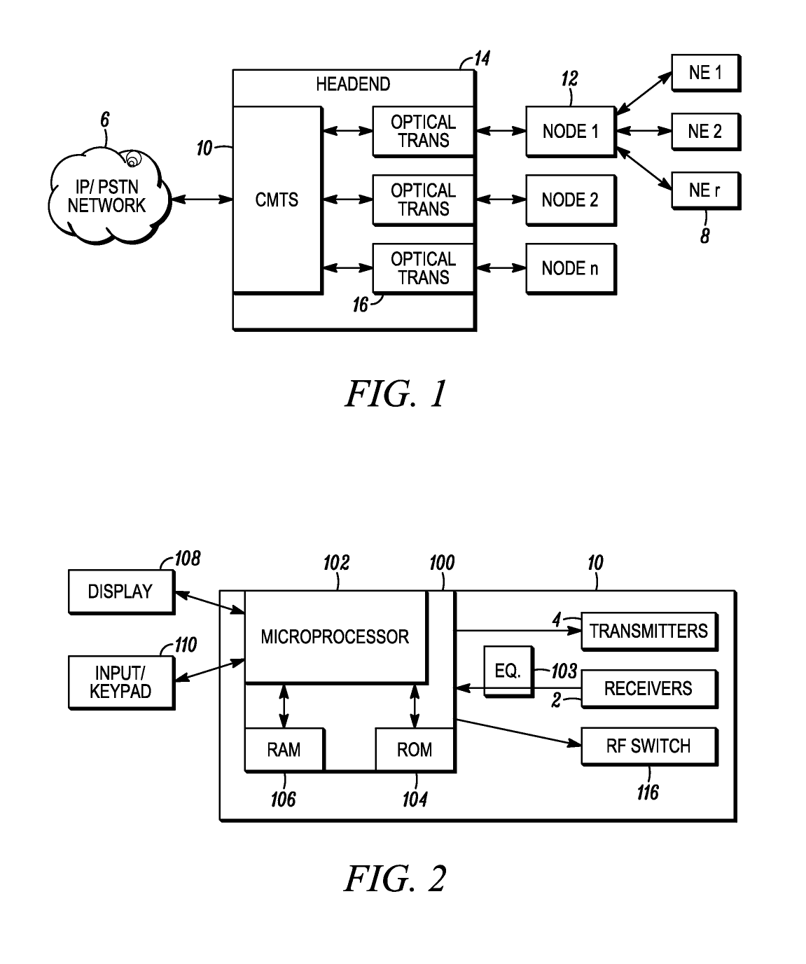

FIG. 1 illustrates an exemplary network in which a plurality of terminal network elements 8 (e.g. cable modems, set top boxes, televisions equipped with set top boxes, or any other element on a network such as a PON or a HFC network) are connected to a cable modem termination system (CMTS) 10 located in a headend 14 through nodes 12 and one or more taps (not shown). In an exemplary arrangement, headend 14 also contains an optical transceiver 16 which provides optical communications through an optical fiber to the plurality of nodes 12. The CMTS 10 connects to an IP or PSTN network 6. Those of skill in the art will appreciate that there may be a plurality of nodes 12 connected to a headend, and a headend may contain a plurality of CMTS 10 units, each of which contain a plurality of receivers (e.g. 8 receivers, or 48 receivers such as in Motorola Mobility, Inc.'s RX48) each of which communicate with a plurality (e.g. 100 s) of network elements 8. The CMTS 10 may also contain a spare receiver which is not continuously configured to network elements 8, but may be selectively configured to network elements 8. Use of a spare receiver is described in commonly assigned Attorney Docket No. BCS03827, assigned U.S. Ser. No. 11/171,066, filed on Jun. 30, 2005 and titled AUTOMATED MONITORING OF A NETWORK, herein incorporated by reference in its entirety.

FIG. 2 illustrates a logical architecture of an exemplary CMTS 10 to facilitate an understanding of the invention. As illustrated in FIG. 2, CMTS 10 may contain a processing unit 100 which may access a RAM 106 and a ROM 104, and may control the operation of the CMTS 10 and RF communication signals to be sent by the network elements 8 to the CMTS 10. Processing unit 100 preferably contains a microprocessor 102 which may receive information, such as instructions and data, from a ROM 104 or RAM 106. Processing unit 100 is preferably connected to a display 108, such as a CRT or LCD display, which may display status information such as whether a station maintenance (SM) is being performed or a receiver is in need of load balancing. An input keypad 110 may also be connected to processing unit 100 and may allow an operator to provide instructions, processing requests and/or data to processor 100.

RF transceiver (transmitter/receiver) unit preferably contains a plurality of transmitters 4 and receivers 2 to provide bi-directional communication with a plurality of network elements 8 through optical transceivers 16, nodes 12 and a plurality of network taps (not shown). Those of skill in the art will appreciate that CMTS 10 may contain a plurality of RF receivers 2, e.g. 8 RF receivers and a spare RF receiver. Each RF receiver 2 may support over 100 network elements. The RF receiver 2, such as a Broadcom 3140 or 3142 receiver, preferably provides the received RF signals to an equalizer 103 which is used to acquire equalizer values and burst modulation error ratio (MER) measurements, packet error rate (PER) and bit error rate (BER). Equalizer 103 is preferably a multiple tap linear equalizer (e.g. a 24 tap linear equalizer), which also may be known as a feed forward equalizer (FFE). Equalizer 103 may be integrally contained in RF receiver 2 or may be a separate device such as an external transmitter. RF receiver 2 may also include an FFT module to support power measurements. The communication characteristics of each receiver 2 may be stored on ROM 104 or RAM 106, or may be provided from an external source, such as headend 14. RAM 104 and/or ROM 106 may also carry instructions for microprocessor 102.

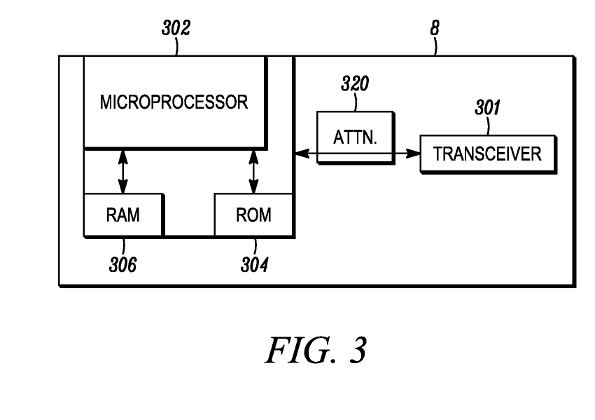

FIG. 3 illustrates an exemplary network element 8, such as a cable modem. Network element 8 preferably contains a processor 302 which may communicate with a RAM 306 and ROM 304, and which controls the general operation of the network element, including the pre-equalization parameters and preamble lengths of communications sent by the network element in accordance with instructions from the CMTS 10. Network element 8 also contains a transceiver (which includes a transmitter and receiver) which provides bidirectional RF communication with CMTS 10. Network element 8 may also contain an equalizer unit which may equalize the communications to CMTS 10. Network element 8 may also contain an attenuator 320 which may be controlled by microprocessor to attenuate signals to be transmitted to be within a desired power level. Those of skill in the art will appreciate that the components of network element 8 have been illustrated separately only for discussion purposes and that various components may be combined in practice.

When network element is connected to a network, it negotiates a registration process with the network, which includes identification of a physical channel (e.g. frequency) for communication with the network and identification of a modulation profile (e.g. logical channel) to communicate with the network. A cable operator may typically configure a CMTS receiver (typically a receiver card) to receive one physical channel but receive a plurality of logical channels (e.g. a physical channel may include two, four or any number of logical channels). Each logical channel may preferably have different modulation profiles. Examples of modulation profiles that may be used include, but are not limited to, QPSK, 8qam, 16qam, 32qam, 128qam and 256qam. Each receiving port typically may receive a logical channel which uses the different modulation profiles. An example would be to have logical channel 0 running QPSK, logical channel 1 running 16QAM, logical channel 2 running 32QAM and logical channel 3 running 64QAM.

Those of skill in the art will appreciate that the different modulation profiles typically provide different bandwidth throughput capability, and that lower or higher modulation profiles relate to lower or higher bandwidth throughput capability. For example, the smallest bandwidth would typically be with the QPSK profile and the largest would typically be with the 256QAM profile. As a further example, 8QAM would have a lower bandwidth than 32QAM, hence, 8QAM has less throughput than 32QAM.

In the registration process, the network element first locks on to a downstream frequency. The network element typically uses the UCD (upstream channel descriptor) and the MAPs to adjust its synchronization with the network and to gather information on upstream channels which to lock on. The MAP provides an interval for an initial ranging opportunity so the network element can register. The network element sends up a ranging request based on the information gathered from the UCD/MAPs. The CMTS will send the ranging response back to the network element. The network element will then use SM (Station Maintenance) messages to stay ranged/registered. There may also be signal power adjustments and synchronization adjustments as well. The MER/SNR for this invention is preferably measured by the CMTS using conventional measurement techniques, e.g. by the receiver, at the time of network element registration. The SNR will be available to be measured while the network element is ranging on the channel.

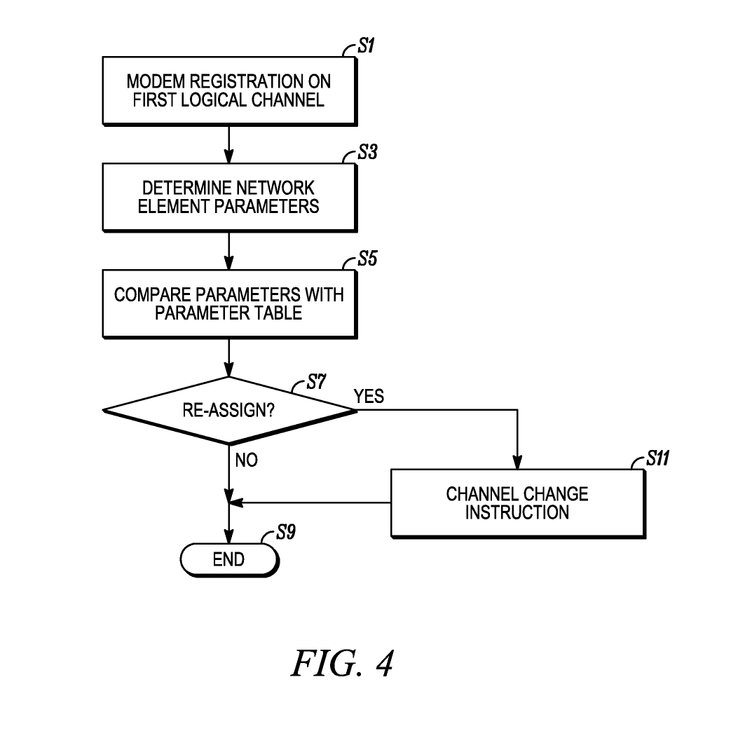

FIG. 4 illustrates an exemplary process performed by a CMTS for automatically registering a network element on a preferred logical channel. As illustrated in step S1 of FIG. 4, a network element is registered with a CMTS port on a first logical channel, such as logical channel 0. Network element parameters, e.g. ranging messages, which are indicative of the performance capabilities of the network element are read by the CMTS, as indicated in step S3. The network element parameters may indicate the network element's MER (SNR) value on the logical channel, as well as other characteristics. As shown in step S5, the network element parameters are compared against a parameter table containing a table of one or more parameter thresholds associated with a logical channel available on the network to determine if the CMTS needs to reassign that modem to a different logical channel on the currently used physical upstream port. The threshold values may be predetermined values or may be dynamically determined based on mathematical techniques such as a mean value of a measured network parameter, or a range of values set by an operator. The network parameters may be sorted in table and displayed in graphical formats, including bar graphs. If the parameters indicate that the characteristics of the network element best align with another logical channel the network element is re-assigned to another logical channel, step S7 Yes by sending a channel change instruction to the network element to re-register and to select the specified logical channel in the instruction, step S11. The channel change instruction may include an upstream channel override message, which causes the network element to re-register itself using the logical channel identified in the message. If the parameters indicate that a new logical channel should not be assigned, step S7, No, the process ends, leaving the network element on its currently assigned logical channel.

As an example parameter thresholds could be as follows: QPSK is set to an MER of 16; 16QAM is set to an MER of 22; 32QAM is set to an MER of 25; and 64QAM is set to an MER of 28. When a modem as the network element registers on logical channel 0 and its MER (SNR) value is 27 the CMTS card will issue an upstream channel override to that particular modem to re-register on logical channel 2 (32QAM) because its MER (SNR) says it can pass data cleanly at that modulation mode. The 32QAM mode will allow the modem the ability to generate better throughput because 32QAM has more bandwidth than the QPSK channel it would have stayed on when it registered the first time. The opposite can happen also if a modem registers on the 32QAM channel but its MER (SNR) value is 18, then it will be directed to override and re-register on lower modulation profile mode (lower bandwidth mode), e.g., logical channel 0 (QPSK). By doing this all the modems will be on the best modulation mode (best bandwidth) it can support and therefore increase throughput potential for all subscribers. In the second example if the modem with an MER of 18 stayed registered on the 32QAM channel, data errors may occur on the modem, prompting the network operator to then reduce the profile of the entire logical channel (including other modems as well), using channel modulation agility techniques, down to QPSK thus reducing the throughput of other modems on that logical channel that could handle 32QAM.

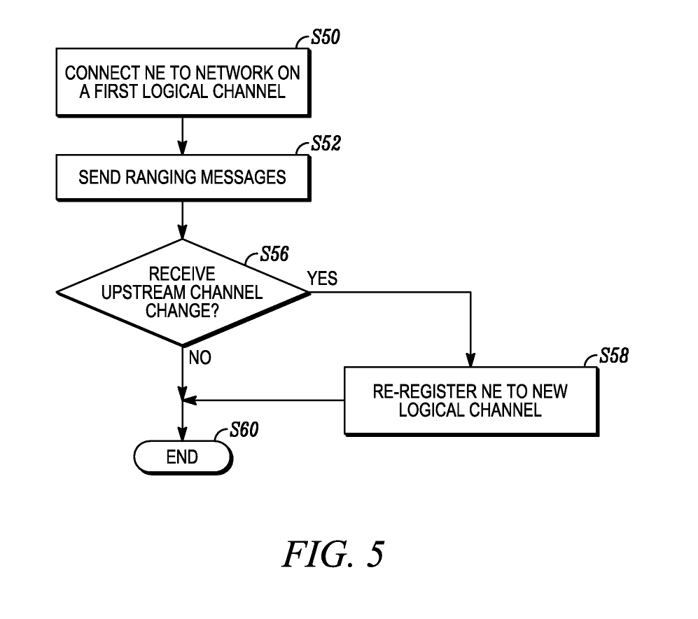

FIG. 5 illustrates an exemplary process in a network element for registering with a network in accordance with the principles of the invention. As illustrated in FIG. 5, step S50, a network element is connected to a network and registers on a physical communication channel (e.g. frequency) and a first logical channel. The first logical channel may be configured as a default registration channel. In the process of registering on the first logical channel, ranging messages are sent to the CMTS, such as initial maintenance or station maintenance messages. The CMTS uses the ranging messages to determine network element parameters or characteristics which indicate performance characteristics and capabilities of the network element on the logical communication channel, step S54. If a channel change request (such as an upstream override instruction) is received, step S56 Yes, the network element is re-registered to a new logical channel, step S58, but remains on the same physical channel. If a channel change request is not received, the network element remains registered on the current logical channel.

One alternative option that may be used is to have the CMTS send initial maintenance messages only on the logical channel that is set for QPSK. This will insure that all modems will not only register but could also initially pass data if necessary. The network element could then be re-registered on the logical channel that best suits its performance characteristics for maximum throughput.

In an implementation, the CMTS or operator may maintain a database indicating where a network element was moved during registration. A problem may happen where a network element has a good MER and looks like it can run at 32QAM when in fact it cannot pass data at the mode after it is moved. It may deregister and re-register. In that case, the CMTS preferably provides instruction to register to a new (a third) logical channel to avoid making the same mistake again. Preferably, the CMTS keeps a record of the previous channel assignments for the network elements and tries to move the network element to another logical channel, such as to the logical channel with the next lower modulation mode. This way we can still get the best throughput for the network element.

In a preferred implementation, the present invention may use a DOCSIS network element, such as a cable modem. The MER and SNR values may be measured by the CMTS during the registration process using known techniques. For example, the test signals may be implemented using one of the available upstream DOCSIS bandwidths, e.g. 200 kHz, 400 kHz, 800 kHz, 1600 kHz, 3200 kHz or 6400 kHz.

The system preferably allows an operator to automatically configure the CMTS to best align the network elements with the available logical channels. The invention provides a cost effective manner for improving network element throughput, providing higher data speeds to subscribers. The total network throughput may also be increased in addition to individual subscriber throughput because each network element will be running at its best possible modulation mode and it should not bring other modems down (to a lower bandwidth) with it. All the modems that can only run in QPSK will be on the QPSK channel, the modems that can run at 16QAM will be on the 16QAM channel and so on. The invention may be done in real time so there are no operator configuration changes or intervention where they could make a mistake and assign a network element to the wrong channel. Another advantage is that there is no or little dollar cost to cable operators to get better throughput.

The processes in FIGS. 4-5 may be implemented in hard wired devices, firmware or software running in a processor. A processing unit for a software or firmware implementation is preferably contained in the CMTS in the case of the process in FIG. 4 and in a network element in the case of the process of FIG. 5. Any of the processes illustrated in FIGS. 4-5 may be contained on a computer readable medium which may be read by microprocessor. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals.

Although described specifically throughout the entirety of the instant disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the examples. While the examples have been described with reference to examples, those skilled in the art are able to make various modifications to the described examples without departing from the scope of the examples as described in the following claims, and their equivalents.

What is claimed is:

1. An apparatus for configuring logical channels in a network comprising:
a microprocessor configured to determine network parameters associated with a selected network element and in cooperation with the selected network element; and
a receiver configured to receive signals indicative of the network element parameters from a network element during a registration process in which the network element is registered on a first logical channel,
wherein the microprocessor is configured to assign the network element to a logical channel based on the network element parameters and to instruct the network element to re-register with the network on a second logical channel different from the first logical channel.

2. The apparatus of claim 1, wherein the network element parameters includes a modulation error ratio (MER) or a signal to noise ratio (SNR).

3. The apparatus of claim 1, wherein the microprocessor compares the network parameters with threshold values and assigns the network elements to a logical channel based on the comparison.

4. The apparatus of claim 1, wherein the microprocessor provides instructions to the network element to re-assign to a third logical channel different from the second logical channel.

5. The apparatus of claim 1, wherein the microprocessor assigns the network element to the second logical channel using an upstream channel override signal.

6. A method for configuring logical channels in a network comprising the steps of:
determining network parameters associated with a network element based on network parameters received from the network element during a registration process in which the network element is registered on a first logical channel;
analyzing the network parameters; and
assigning network elements to a second logical channel based on the network parameters, and to instruct the network element to re-register with the network on the second logical channel different from the first logical channel.

7. The method of claim 6, wherein the network parameters includes a modulation error ratio (MER) or a signal to noise ratio (SNR).

8. The method of claim 6, wherein the step of assigning network elements to logical channels includes comparing the network parameters with threshold values and assigning the network elements to a logical channel based on the comparison.

9. The method of claim 6, further including the step of providing instructions to the network element to re-assign to a third logical channel different from the second logical channel.

10. The method of claim 6, wherein the step of assigning the network element to a second logical channel includes instructing the network element to the second logical channel using an upstream channel override signal.

11. A non-transitory computer readable medium carrying instructions for a computer to perform a method for configuring logical channels in a network comprising the steps of:
determining network parameters associated with a network element based on network parameters received from the network element during a registration process in which the network element is registered on a first logical channel;
analyzing the network parameters; and
assigning network elements to a second logical channel based on the network parameters, and to instruct the network element to re-register with the network on the second logical channel different from the first logical channel.

12. The computer readable medium of claim 11, wherein the network parameters includes a modulation error ratio (MER) or a signal to noise ratio (SNR).

13. The computer readable medium of claim 11, wherein the step of assigning network elements to logical channels includes comparing the network parameters with threshold values and assigning the network elements to a logical channel based on the comparison.

14. The computer readable medium of claim 11, further including the step of providing instructions to the network element to re-assign to a third logical channel different from the second logical channel.

15. The computer readable medium of claim 11, wherein the step of assigning the network element to a second logical channel includes instructing the network element to the second logical channel using an upstream channel override signal.

13. A network element in a network comprising:
a microprocessor configured to register with a network on a physical channel and a first logical channel and to provide messages indicative of network element parameters associated with the network element's ability to communicate on the channel; and
a receiver configured to receive a upstream channel override signal;
wherein the upstream channel override signal instructs the network element to re-register on a second logical channel.

14. The apparatus of claim 13, wherein the network element parameters includes a modulation error ratio (MER) or a signal to noise ratio (SNR).

15. The apparatus of claim 13, wherein the microprocessor re-registers with the network on the second logical channel.

16. A method for configuring logical channels element in a network comprising the steps of:
registering with a network on a physical channel and a first logical channel;
providing messages indicative of network element parameters to a network controller;
receiving an upstream channel override signal; and
re-registering the network element on a second logical channel different from the first logical channel.

17. The method of claim 16, wherein the network element parameters includes a modulation error ratio (MER) or a signal to noise ratio (SNR).

18. A non-transitory computer readable medium carrying instructions for a computer to perform a method for configuring logical channels in a network comprising the steps of:
registering with a network on a physical channel and a first logical channel;
providing messages indicative of network element parameters to a network controller;
receiving an upstream channel override signal; and
re-registering the network element on a second logical channel different from the first logical channel.

19. The computer readable medium of claim 18, wherein the network parameters includes a modulation error ratio (MER) or a signal to noise ratio (SNR).
